(19) United States
(12) Patent Application Publication
(10) Pub. No.: US 2014/0297718 A1
(43) Pub. Date: Oct. 2, 2014

(54) APPARATUS AND METHOD FOR TRANSMITTING IMAGE OF MULTI-USER

(71) Applicant: Electronics and Telecommunications Research Institute, Daejeon (KR)

(72) Inventor: Chanho PARK, Daejeon (KR)

(21) Appl. No.: 13/916,808

(22) Filed: Jun. 13, 2013

(30) Foreign Application Priority Data
Mar. 27, 2013 (KR) 10-2013-0033055

(51) Int. Cl. H04L 29/06

(52) U.S. Cl. CPC H04L 67/42
USPC 709/203

(57) ABSTRACT

A multi-user image transmitting apparatus is mounted in a slot of a server, and when a plurality of users send a request for an image to the server, the multi-user image transmitting apparatus converts a plurality of image signals that are output from a plurality of video cards that are mounted in the server to a plurality of image data, respectively, converts the plurality of image data to a plurality of user datagram protocol (UDP) image packets, respectively, and transmits the UDP image packets to a plurality of user terminals through a network.

### CROSS-REFERENCE TO RELATED APPLICATION

This application claims priority to and the benefit of Korean Patent Application No. 10-2013-0033055 filed in the Korean Intellectual Property Office on Mar. 27, 2013, the entire contents of which are incorporated herein by reference.

### BACKGROUND OF THE INVENTION

(a) Field of the Invention

The present invention relates to a method and apparatus for transmitting a multi-user's image. More particularly, the present invention relates to a method and apparatus for transmitting a multi-user's image through a network.

(b) Description of the Related Art

For server-based computing or remote use of a personal computer (PC), remote transmission of an image signal is required. For this purpose, a much used method is technology using a protocol such as RDP of Microsoft, ICA of Citrix, and PCoIP of VMwear. Such technology is software technology that is much used for transmitting an image to a user in a virtualization environment, and has problems for supporting 3D graphic applications. The system may be serviced to relatively many users, but it is difficult for the system to service a high quality of image, and the system has long latency.

In order to overcome this, technology that virtualizes a graphics processing unit (GPU) and that uses a pass-through method in a virtual machine has been developed. RemoteFx of Microsoft and HDX of Citrix can utilize this GPU. However, number of user is small and the cost per user is very expensive.

In addition to the virtualization solution, a virtualization method of allocating separate hardware to each user with a pass-through method is applied, and in this case, a user terminal is mostly connected by a direct cable.

A network keyboard, video, and mouse (hereinafter referred to as “KVM”) switch is an apparatus for enabling access of a PC to anywhere that is connected by a network and is technology that directly receives and transmits an image output. However, the network KVM switch exists as separate equipment external to the PC, and compresses an image using an embedded processor and uses a separate communication protocol and thus latency is extended, whereby, in an application field requiring a real-time image, the network KVM switch cannot be used.

### SUMMARY OF THE INVENTION

A transmission control protocol (TCP), a user datagram protocol (UDP), and an Internet protocol (IP) are protocols for data transmission in a network, and a CPU generally processes the protocol. As a network bandwidth is widened, the foregoing protocol processing operates as a burden to the CPU. In order to solve this, use of a TCP/IP offload engine (TOE) technology was started. TOE technology is technology that enhances network performance and that relieves a burden of the CPU by processing TCP, UDP, and IP protocols by hardware in a network card. The UDP protocol has no retransmission function, but because the UDP protocol can be processed relatively simpler than the TCP protocol, the UDP protocol can be easily embodied by hardware, and in providing a real-time image, retransmission due to an error is unnecessary and thus the UDP protocol is appropriate to use.

The present invention has been made in an effort to provide a method and apparatus for transmitting a multi-user's image through a network using a protocol using a UDP.

An exemplary embodiment of the present invention provides a multi-user image transmitting apparatus that transmits an image of a server through a network. The multi-user image transmitting apparatus includes a plurality of image analysis units, a UDP processing engine, and a media access control (MAC) processor. The plurality of image analysis units convert a plurality of image signals that are output from a plurality of video cards that are mounted in the server to a plurality of image data, respectively. The UDP processing engine converts the plurality of image data to a plurality of UDP image packets, respectively. The media access control (MAC) processor transmits the plurality of UDP image packets to a plurality of user terminals through the network.

The multi-user image transmitting apparatus may be mounted in a slot of the server.

The multi-user image transmitting apparatus may further include an address resolution protocol/Internet control message protocol (ARP/ICMP) processing engine. The ARP/ICMP processing engine may determine a MAC address corresponding to an IP of the plurality of user terminals and forward the MAC address to the UDP processing engine.

The ARP/ICMP processing engine may transmit an ARP request packet through the network, receive the ARP request packet through an ARP response packet, and extract a MAC address corresponding to the IP of the plurality of user terminals.

The ARP/ICMP processing engine may periodically transmit the ARP request packet.

The multi-user image transmitting apparatus may further include a plurality of image processors. The plurality of image processors may compress the plurality of image data, respectively.

The plurality of image processors may each compress the image data with an h.264 compression method and lower a compression rate of an i-frame, when the image data is a text image.

Another embodiment of the present invention provides a method in which a multi-user image transmitting apparatus transmits an image of a server through a network. The method includes: converting, when a plurality of users send a request for an image to the server, a plurality of image signals that are output from a plurality of video cards that are mounted in the server to a plurality of image data; converting the plurality of image data to a plurality of UDP image packets, respectively; and transmitting the plurality of UDP image packets to the plurality of user terminals through the network.

The method may further include at least one of compressing each of the plurality of image data, and encoding the plurality of image data.

The compressing of each may include compressing the plurality of image data with an h.264 compression method, and determining whether the image data is a motion picture or a text image and adjusting a compression rate of an i-frame.

### BRIEF DESCRIPTION OF THE DRAWINGS

FIG. 1 is a diagram illustrating a multi-user image transmitting apparatus according to an exemplary embodiment of the present invention.

FIG. 2 is a block diagram illustrating a configuration of the multi-user image transmitting apparatus of FIG. 1.

FIG. 3 is a diagram illustrating an example of a necessary register set when a multi-user image transmitting apparatus and a host processor communicate according to an exemplary embodiment of the present invention.

FIG. 4 is a block diagram illustrating an image receiving card of FIG. 1.

FIG. 5 is a flowchart illustrating a method of transmitting an image signal in a multi-user image transmitting apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for transmitting a multi-user's image according to an exemplary embodiment of the present invention will be described in detail with reference to the drawings.

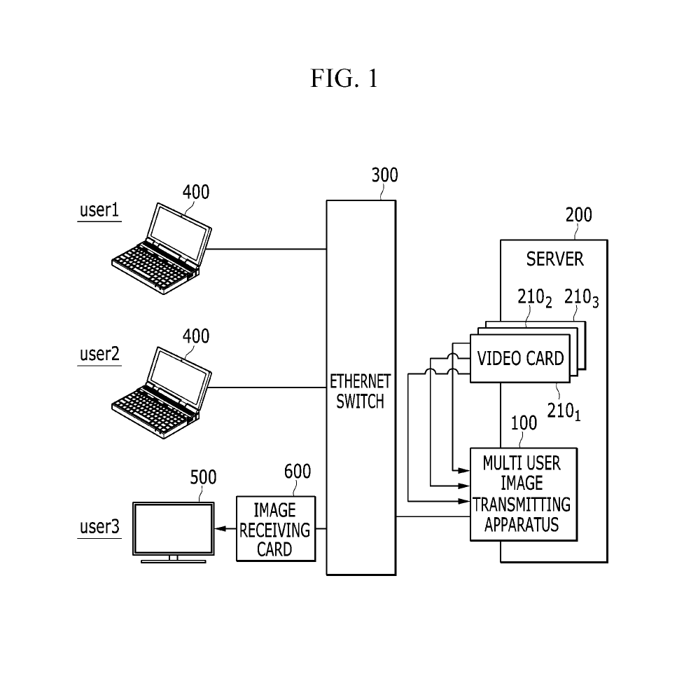

FIG. 1 is a diagram illustrating a multi-user image transmitting apparatus according to an exemplary embodiment of the present invention.

Referring to FIG. 1, a multi-user image transmitting apparatus 100 according to an exemplary embodiment of the present invention is an image transmitting card, is mounted in a slot of a PC or a server (hereinafter referred to as a “server”) 200, forms an image signal that is output from at least one of video cards 210₁, 210₂, and 210₃ that are mounted in the server 200 in a packet, and transmits the packet to an Ethernet switch 300.

The Ethernet switch 300 forwards an image packet, having been received from the multi-user image transmitting apparatus 100, to a corresponding destination port.

User0-user3 each receive an image signal through a user terminal 400 or a display device 500.

The user terminal 400 is an apparatus such as a PC, and processes and displays an image packet that is received from the Ethernet switch 300. The display device 500 is a device that performs a function of displaying an image signal like a monitor. The display device 500 requires an apparatus for processing an image packet from the Ethernet switch 300. In this case, an image receiving card 600 processes an image packet that is received from the Ethernet switch 300 and forwards an image signal to the display device 500.

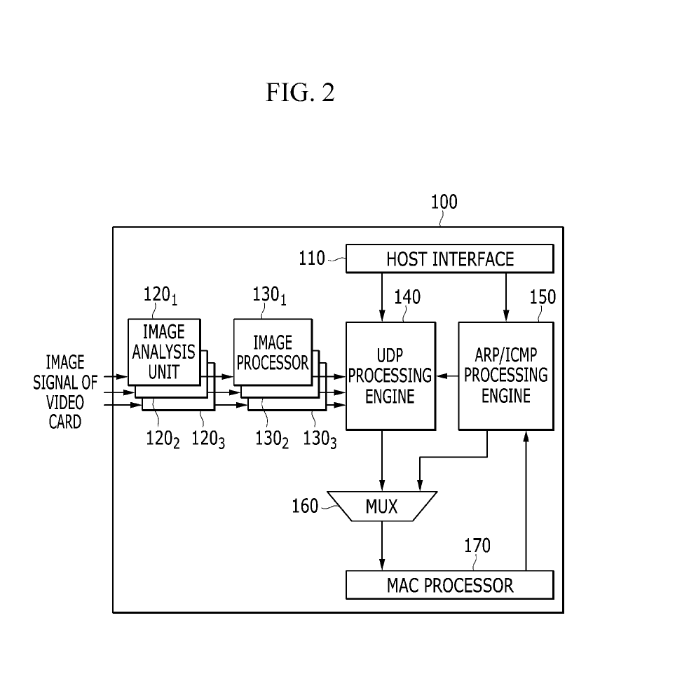

FIG. 2 is a block diagram illustrating a configuration of the multi-user image transmitting apparatus of FIG. 1.

Referring to FIG. 2, the multi-user image transmitting apparatus 100 includes a host interface 110, at least one of image analysis units 120₁, 120₂, and 120₃, at least one of image processors 130₁, 130₂, and 130₃, a UDP processing engine 140, an address resolution protocol/Internet control message protocol (ARP/ICMP) processing engine 150, a multiplexer 160 (hereinafter referred to as a “MUX”), and a media access control (MAC) processor 170. The host interface 110 performs an interface with a host processor of the server 200.

The image processors 130₁, 130₂, and 130₃ compress image data that is received from the image analysis units 120₁, 120₂, and 120₃, respectively, and forward the compressed image data to the UDP processing engine 140. When a resolution of the image data is low or when a bandwidth of the image data is appropriate, compression of image data may not be performed, and the image data may be forwarded to the UDP processing engine 140. Further, image processors 130₁, 130₂, and 130₃ may encode image data that is received from the image analysis units 120₁, 120₂, and 120₃ and forward the encoded image data to the UDP processing engine 140.

When the image processors 130₁, 130₂, and 130₃ use a most widely used H.264 encoding technique of present compression methods, a situation that a font of a text screen is blurred often occurs. In order to reduce this situation, the image analysis units 120₁, 120₂, and 120₃ each measure a change state of image data, determine whether an image signal is a text image, and notify the image processors 130₁, 130₂, and 130₃ of this, and if an image signal is a text image, the image processors 130₁, 130₂, and 130₃ lower and compress a compression rate of an I-frame, thereby making the text more clear.

The UDP processing engine 140 converts the compressed image data to an image packet, which is an Ethernet packet form, and forwards the image packet to the MUX 160. The conversion operation is operation of dividing large image data into image data of a size that may be allowed in a network, and generating and adding a MAC header, an IP header, and an UDP header. Further, several header fields necessary for forwarding graphics data may be added. In this case, the host processor records necessary information (e.g., another party's IP information) at a register of the UDP processing engine 140.

The ARP/ICMP processing engine 150 performs three functions.

A first function of the ARP/ICMP processing engine 150 is a function of searching for a MAC address of another party's IP before first transmitting an image packet to the other party's IP. That is, the ARP/ICMP processing engine 150 generates an ARP request packet, transmits the ARP request packet through the MUX 160 and the MAC processor 170, receives an ARP response packet from another party's terminal, extracts a MAC address of another party's IP, and forwards the MAC address to the UDP processing engine 140.

A second function of the ARP/ICMP processing engine 150 is a function of determining whether a connection to another party's terminal has been continued by periodically sending an ARP request packet to the other party's IP. Because a UDP protocol does not use an acknowledge (ACK) packet, the ARP/ICMP processing engine 150 determines whether a connection to another party's terminal has been continued, with an ARP request packet.

A third function of the ARP/ICMP processing engine 150 is a function of processing an ICMP packet. Even if a physical connection has been continued, communication using a corresponding port may be unavailable. In this case, the other party's terminal sends a message such as “destination unreachable” using ICMP. The ARP/ICMP processing engine 150 receives and processes an ICMP packet such as such a message. When a connection is interrupted or when communication using a corresponding port is unavailable, the ARP/ICMP processing engine 150 notifies the host processor of this with interruption through the host interface 110, and by notifying together with the other party's IP, the ARP/ICMP processing engine 150 enables the host processor to know which one of the other party's terminals was interrupted.

The ARP/ICMP processing engine 150 discards all other received packets, except for an ARP response packet and an ICMP packet.

The MUX 160 forwards an ARP request packet and a UDP image packet to the MAC processor 170 through arbitration.

The MAC processor 170 transmits to and receives a packet from the Ethernet switch 300 of a network. The MAC processor 170 forwards the ARP packet and the UDP packet that are received from the MUX 160 to the Ethernet switch 300 of the network, and forwards the packet that is received through the Ethernet switch 300 of the network to the ARP/ICMP processing engine 150.

In this way, the multi-user image transmitting apparatus 100 converts an image signal of the video cards 210₁, 210₂, and 210₃ to a UDP image packet using a UDP protocol, thereby directly transmitting a corresponding image signal through the network.

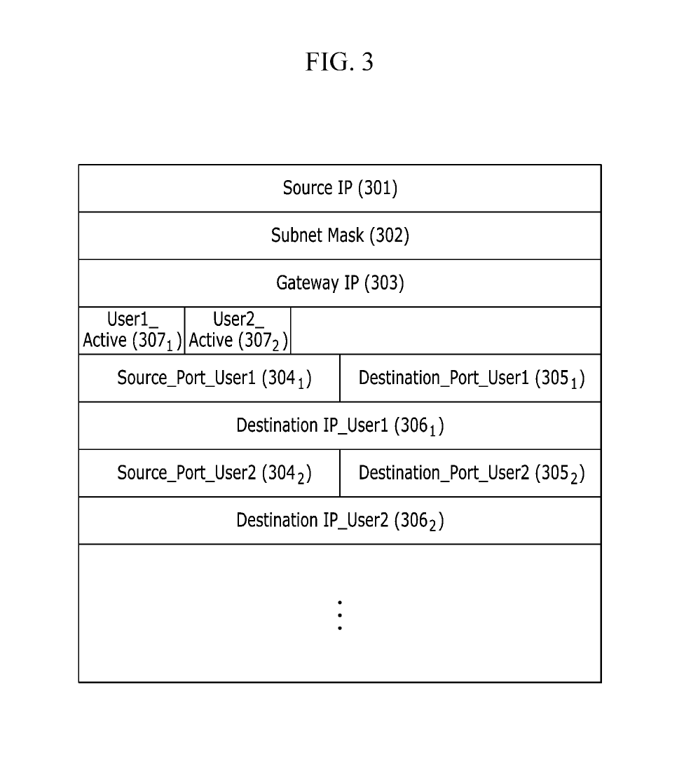

FIG. 3 is a diagram illustrating an example of a necessary register set when a multi-user image transmitting apparatus and a host processor communicate according to an exemplary embodiment of the present invention.

Referring to FIG. 3, when the host processor of the server 200 recognizes the multi-user image transmitting apparatus 100, the host processor records a source IP, a subnet mask, and a gateway IP as information of the server 200 at corresponding fields 301, 302, and 303, respectively, of the register.

When a user1 and a user2 send a request for an image to the server 200, the host processor records Destination_IP_user1 and Destination_IP_user2 of the corresponding user1 and user2 and Source_port_user1 and Source_port_user2 and Destination_port_user1 and Destination_port_user2 to use at corresponding fields 306₁, 306₂, 304₁, 304₂, 305₁, and 305₂, respectively, of the register. FIG. 3 illustrates that the server 200 uses only one source IP and connects Source_port_user1 and Source_port_user2 to use to the changing user1 and user2, but may differently use the source IP.

Next, the host processor records, at corresponding fields 307₁ and 307₂, that the user1 and the user2 are in user1_Active state and user2_Active state.

When the user1 and the user2 are in an active state, in order to search for a MAC address corresponding to a destination IP, the ARP/ICMP processing engine 150 performs ARP processing. When the MAC address overpasses a subnet mask, the ARP/ICMP processing engine 150 searches for a MAC address of the gateway. The ARP/ICMP processing engine 150 forwards a MAC address of the founded destination to the UDP processing engine 140, and the UDP processing engine 140 transmits image data, having been received from the image processors 130₁, 130₂, and 130₃, to the corresponding user1 and user2 using a MAC address corresponding to the destination IP.

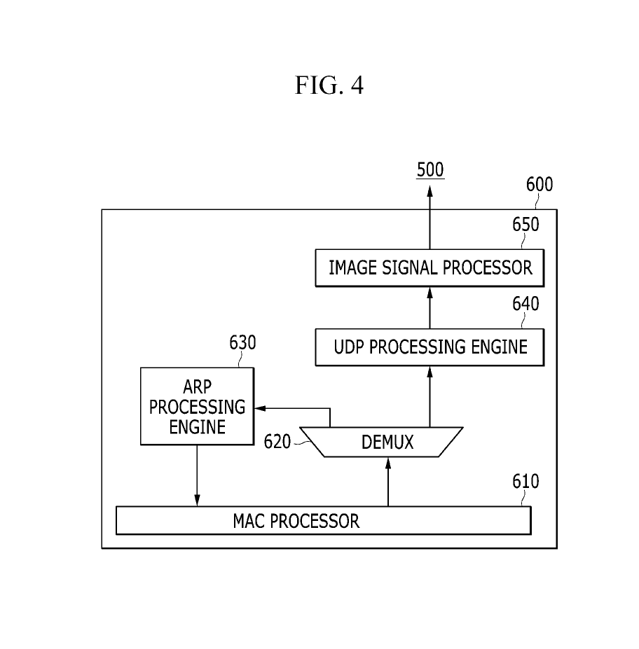

FIG. 4 is a block diagram illustrating an image receiving card of FIG. 1.

Referring to FIG. 4, the image receiving card 600 includes a MAC processor 610, a demultiplexer 620 (hereinafter referred to as a “DEMUX”), an ARP processing engine 630, a UDP processing engine 640, and an image signal processor 650.

The MAC processor 610 transmits to and receives a packet from the Ethernet switch 300 of a network. The MAC processor 610 forwards a packet, having been received from the Ethernet switch 300 of the network, to the DEMUX 620, and forwards an ARP response packet, having been received from the ARP processing engine 630, to the Ethernet switch 300 of the network.

The DEMUX 620 determines whether the received packet is an ARP request packet or an UDP image packet, and if the received packet is an ARP request packet, the DEMUX 620 forwards the received packet to the ARP processing engine 630, while if the received packet is an UDP image packet, the DEMUX 620 forwards the received packet to the UDP processing engine 640. If the received packet is not an ARP request packet or an UDP image packet, the DEMUX 620 discards the received packet.

When the ARP request packet is received, the ARP processing engine 630 generates an ARP response packet to the ARP request packet and forwards the ARP response packet to the MAC processor 610. The ARP/ICMP processing engine 150 of FIG. 2 is different from the ARP processing engine 630. The ARP/ICMP processing engine 150 of FIG. 2 generates an APR request packet, and the ARP processing engine 630 generates an APR response packet. Further, because a port to receive is always prepared, the ARP processing engine 630 does not generate an ICMP packet.

The UDP processing engine 640 extracts the received UDP image packet and forwards the UDP image packet to the image signal processor 650. All UDP packets, except for an UDP packet that is received by a previously promised port, are discarded. Further, when a frame having a problem or a disappeared frame exists, the UDP processing engine 640 forwards an error signal to the image signal processor 650.

When image data of the UDP image packet, having been received from the UDP processing engine 640, is compressed or encoded, the image signal processor 650 decodes the image data, converts the image data to an RGB or DVI image signal, and forwards the RGB or DVI image signal to the monitor 500.

The image receiving card 600 enables a user to receive and view an image without a system of a PC form.

The user terminal 400 performs a function of the image receiving card 600.

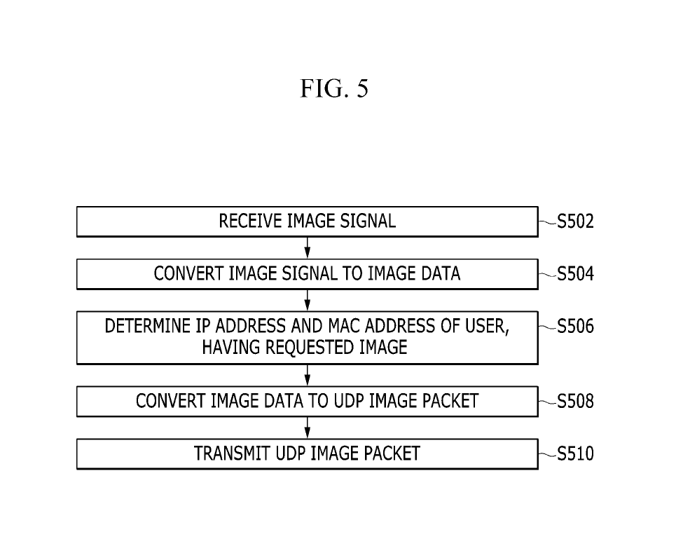

FIG. 5 is a flowchart illustrating a method of transmitting an image signal in a multi-user image transmitting apparatus according to an exemplary embodiment of the present invention.

In FIG. 5, it is assumed that a user1 and a user2 send a request for an image to the server 200.

As described above, when a host processor of the server 200 recognizes the multi-user image transmitting apparatus 100, the host processor records a source IP, a subnet mask, and a gateway IP at corresponding fields 301, 302, and 303, respectively, of a register. When the user1 and the user2 send a request for an image to the server 200, the host processor records Destination IP_user1 and Destination_IP_user2 of the corresponding user1 and user2, and Source_port_user1 and Source_port_user2 to use and Destination_port_user1 and Destination_port_user2 at corresponding fields 306₁, 306₂, 304₁, 304₂, 305₁, and 305₂, respectively, of a register.

The video cards 210₁ and 210₂ output an image signal according to an image request of the user1 and the user2. In this case, the number of video cards that output an image signal may correspond to the number of user terminals that request an image.

Referring to FIG. 5, when the image analysis units 120₁ and 120₂ receive an RGB or DVI image signal that is output from the video cards 210₁ and 210₂ (S502), the image analysis units 120₁ and 120₂ convert the received RGB or DVI image signal to image data (S504) and forward the converted image data to the UDP processing engine 140. In this case, the image processors 130₁ and 130₂ compress and/or encode image data that is converted by the image analysis units 120₁ and 120₂ and forward the compressed and/or encoded image data to the UDP processing engine 140.

The UDP processing engine 140 converts image data to an UDP image packet of an UDP packet form. For this purpose, the ARP/ICMP processing engine 150 determines an IP address and a MAC address of the user1 and the user2 having requested an image (S506), and forwards the MAC addresses of the found user1 and user2 to the UDP processing engine 140. The UDP processing engine 140 converts compressed and/or encoded image data to a UDP image packet using the MAC addresses of the user1 and user2 (S508).

The UDP processing engine 140 transmits the UDP image packet using the network through the MAC processor 170 (S510).

According to an exemplary embodiment of the present invention, image transmission having low latency is available, and by supporting a multi-user, in a virtualization environment, an application requiring a real-time image such as a game can be used.

Further, by using a network packet form unlike extension of a simple cable, user connection can be easily performed using a MAC address and IP.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A multi-user image transmitting apparatus that transmits an image of a server through a network, comprising:
a plurality of image analysis units that convert a plurality of image signals that are output from a plurality of video cards that are mounted in the server to a plurality of image data, respectively;
a UDP processing engine that converts the plurality of image data to a plurality of user datagram protocol (UDP) image packets, respectively; and
a media access control (MAC) processor that transmits the plurality of UDP image packets to a plurality of user terminals through the network.

2. The multi-user image transmitting apparatus of claim 1, wherein the multi-user image transmitting apparatus is mounted in a slot of the server.

3. The multi-user image transmitting apparatus of claim 1, further comprising an address resolution protocol/Internet control message protocol (ARP/ICMP) processing engine that determines a MAC address corresponding to an IP of the plurality of user terminals and that forwards the MAC address to the UDP processing engine.

4. The multi-user image transmitting apparatus of claim 3, wherein the ARP/ICMP processing engine transmits an ARP request packet through the network, receives the ARP request packet through an ARP response packet, and extracts a MAC address corresponding to IP of the plurality of user terminals.

5. The multi-user image transmitting apparatus of claim 4, wherein the ARP/ICMP processing engine periodically transmits the ARP request packet.

6. The multi-user image transmitting apparatus of claim 1, further comprising a plurality of image processors that compress the plurality of image data, respectively.

7. The multi-user image transmitting apparatus of claim 6, wherein the plurality of image processors each compress the image data with an h.264 compression method and lower a compression rate of an i-frame, when the image data is a text image.

8. The multi-user image transmitting apparatus of claim 1, further comprising a plurality of image processors that encode the plurality of image data, respectively.

9. A method in which a multi-user image transmitting apparatus transmits an image of a server through a network, the method comprising:
converting, when a plurality of users send a request for an image to the server, a plurality of image signals that are output from a plurality of video cards that are mounted in the server to a plurality of image data;
converting the plurality of image data to a plurality of UDP image packets, respectively; and
transmitting the plurality of UDP image packets to the plurality of user terminals through the network.

10. The method of claim 9, further comprising at least one of:
compressing each of the plurality of image data; and
encoding the plurality of image data.

11. The method of claim 10, wherein the compressing of each of the plurality of image data comprises:
compressing the plurality of image data with an h.264 compression method; and
determining whether the image data is a motion picture or a text image and adjusting a compressing rate of an i-frame.

12. The method of claim 9, wherein the multi-user image transmitting apparatus is mounted in a slot of the server.
